(19) United States
(12) Patent Application Publication
(10) Pub. No.: US 2023/0301865 A1
(43) Pub. Date: Sep. 28, 2023

(54) Cane Tip Attachment for a Safety Cane

(71) Applicants: JOHN MCATEER, HIGH RIDGE, MO (US); ALEJANDRO EILBERG, WINNIPEG (CA)

(72) Inventors: JOHN MCATEER, HIGH RIDGE, MO (US); ALEJANDRO EILBERG, WINNIPEG (CA)

(21) Appl. No.: 18/124,738

(22) Filed: Mar. 22, 2023

Related U.S. Application Data
(60) Provisional application No. 63/372,589, filed on Mar. 22, 2022.

(51) Int. Cl. A61H 3/06

(52) U.S. Cl. CPC A61H 3/068; A61H 2201/1673; A61H 2201/0165

(57) ABSTRACT

A cane tip has a first roller and second roller, each roller having a semispherical exterior surface with a peripheral edge surface having a circular configuration. The peripheral edge surfaces are designed to engage with and roll over a support surface when the cane tip is being moved forwardly and rearwardly to reduce impact forces from being transmitted up the cane to the user's hand and arm. The spherical exterior surfaces are designed to engage with and roll over the support surface when the cane tip is moved from side to side while reducing impact forces from traveling up the cane to the hand and arm of a user of the cane tip.

### CROSS-REFERENCE TO RELATED APPLICATIONS

This application claims the benefit of the filing date and incorporates in its entirety Provisional Application Ser. No. 63/372,589 which was filed on Mar. 22, 2022.

### FIELD OF THE INVENTION

This invention relates to a cane, and more particularly to a safety cane of the type that is utilized by a blind person or near blind person. The cane is used for the safety of the user, particularly when traversing various areas either in the home, outside, on the street, and also when making a street crossing. The cane tip or swivel ball means attaches to the bottom of the cane and makes it far easier to motivate using the cane. The tip formed as a ball can swivel and roll in all directions, while riding upon the associated surface, and avoid the impacting problems that occur with the use of the standard cane, without any swivel tip attachment.

### BACKGROUND OF THE INVENTION

A visually impaired or blind person has been utilizing the white cane for years. It is known that there is approximately 7,895,900 visually impaired or disabled individuals in the United States, through the accumulation of statistics just a few years ago. Many of these disabled individuals are non-institutionalized individuals. Therefore, many live at home, or some residence, some living on their own. The need for some type of improvement to the cane that facilitates the movement of the visually impaired individual is always a welcome improvement.

When using a conventional a white cane, frequently the user will encounter an obstruction that abruptly impacts the tip of the cane, transmitting an impact force back to the hand and arm of the user. When these impacts are repeated over and during a period of time, they have the effect of generating a degree of discomfort in the hand and wrist of the user, similar to developing the impairment identified as carpal tunnel syndrome effect.

Thus, there is a need to lessen the effects of such repeated impacts and enable the visually impaired to avoid such inconvenient activity and maintain a normal lifestyle, each day, without problems.

With the current invention, an effort is made to make it easier for the visually impaired or blind person to motivate while walking, as previously stated, either in the home, around the premises, on the block, and particularly when crossing streets. The purpose of this invention is to facilitate the movement of the lower tip of the cane over the surface, avoid the type of impacts as previously explained, and make it easier for the user to move, from one place to another, during usage of this invention.

The inventor herein, has previously obtained U.S. Pat. No. 10,898,406, upon a collapsible safety cane with shock absorbing features, which is incorporated herein by references. The current invention is designed to be used with this cane or an equivalent cane to add to the facility of the operation of the bottom of the cane, through the use of an attached tip with a multi rotatable swivel ball, that allows the cane to move freely over the surface, even a roughened surface, and thereby reduce the incidence of impact that frequently occurs with the standard white cane, when used and applied for such purposes.

### SUMMARY OF THE INVENTION

As stated, the invention relates to the application of a multi-rotatable roller ball to the bottom tip of a white cane, or any type of cane to help the handicapped, for that matter, so as to make it easier to utilize the cane and roll over the forward surface from the user, during application.

The application of the spherical type ball, in two halves to the bottom of the cane, and one that will roll forwardly upon movement of the person and his/her white cane, and at the same time, when lateral movement is undertaken, swivel in the aligning direction, greatly facilitates the safe movement of the handicapped, and reduces the incidence of impacting minor obstacles, or rough terrain, during its usage.

The rolling ball cane tip of this invention, applied to a white cane, for the blind, visually impaired, or even the handicapped, incorporates a ball and the cane lower tip, primarily in the form of a rolling ball located at the bottom end of the cane, and allows the ball to roll and swivel in 360 degree rotation. You can attach the bottom end of the cane by various means, such as it can attached to the bungee cord that is located inside the cane shaft, of the type as previously reviewed in the inventors prior U.S. Pat. No. 10,898,406. When attached in that manner, and when in use, the ball swivels in any direction, allowing for much less friction, easier to control, furnishes better tactile feel to the user, less hangups on obstacles, longer lasting resistance to wear, and is safer and easier to use.

In addition, the swivel ball can attach by other means of attachment to the bottom of the cane, whether it be by fastening cap, or screwed in place, that yet allows for the associated support shaft to rotate, so that horizontal swiveling of the swivel ball can be achieved, depending upon the direction of movement of the user, during its application.

When the swiveling ball assembly is designed for attaching to the bungee cord within the cane shaft, this secures the entire assembly to the cane bottom, to achieve its operational purposes. When attached to the bungee type cord, the assembly includes a shield that slides over a support shaft, and is secured by a binding or pressured heat process, or screwed in place, so that the shield can't hold the identified support shaft for rotatable and pivotal movement, during its usage. The attached support shaft is also provided at its lower end for securing a bearing for holding a center shaft that is attached to two hemispherical ball pieces as by a bond or heat melt process, or which even can be threadedly engaged within the diametrical center and across between the two ball halves, during its assembly. Thus, the swivel ball can rotate vertically relative to the bottom of the cane, while at the same time the bearing mounting of the support shaft within the associated shield allows for swivel movement, horizontally, of the swivel ball at the bottom of the cane, during its usage. Thus, multiple directions of pivot and rotation of the swivel ball at the bottom of the white cane makes it much more easier for the individual user to glide the cane over a surface, regardless of what direction the cane is oriented, during its usage.

Thus, as described, through the multiple pivotable and rotatable mounting of the swivel ball to the bottom of the cane, the attachment can roll forwardly, backwards, side to side, and any angle desired, which allows for the rolling ball to move much better over a surface, with less fatigue to the user. The swivel ball provides better tactile usage by the user, and rolls over obstacles far better, and with less hangups and jabs, as encountered by the standard white cane.

Less friction in the movement of the swivel ball means less wear for a longer lasting cane tip. Various stainless steel bearings mounted to various components for pivotal and rotatable movement together, and a holding of the various center support shafts, provide extra strong construction, and resist any rust or rotation, particularly when the cane may frequently be used outdoors, even in inclement weather, as it rolls over surfaces, during usage. Thus, this is an all-weather product that allows the user to travel in hot, cold, rain or light snow, whatever the person requires transit. It makes such a white cane far more pleasurable to utilize, and provides for this guide cane to be used with constant ground contact, during its application.

Furthermore, the means operatively associated between the two halves of the spherical ball, rubbing against the support shaft, which helps to keep the space between the roller ball halves empty of any debris, as during continuous usage. And, gasket means may be provided at the periphery of the ball halves, that helped to keep the interior of the swivel ball clean, and prevent dirt from accumulating around the bearing provided between the support shaft, and the center shaft, that forms the structure of the swivel ball construction.

The cane tip of this disclosure has a swivel ball type construction that is comprised of a base, an axle, and a roller or rollers. Each of these component parts is constructed of a material that provides the cane tip with sufficient structural strength for functioning in its intended manner.

The base has a support shaft or an attachment projection that extends upwardly from the base. The attachment projection is configured to be attachable to a distal end or a bottom end of a cane, such as a white cane. The attachment projection has a projection axis that is positioned coaxially with a center axis of the cane when the attachment projection is attached to the cane.

The axle is positioned on the base below the attachment projection. The axle has an axle axis that is oriented perpendicular to the projection axis of the attachment projection. The axle is a separate component part from the base and is mounted on the base for rotation of the axle on the base. The axle has a first distal end that projects from a first side of the base and the axle has a second distal end that projects from a second side of the base.

The roller is comprised of a pair of rollers or a first roller and a second roller. The rollers have exterior configurations that are mirror images of each other. Each roller has an exterior surface with a hemispherical or semispherical configuration that is configured to engage against and move across a support surface supporting a user of the cane tip, for example a sidewalk surface that the user is walking across. The first roller and the second roller are each mounted on the axle for rotation of the rollers on the axle and rotation of the rollers around the axle axis. The first roller is mounted on the first distal end of the axle on the first side of the base and the second roller is mounted on the second distal end of the axle on the second side of the base.

The first roller has a peripheral edge around the semispherical configuration of the first roller. The peripheral edge has a circular configuration that is concentric with the axle axis.

The second roller also has a peripheral edge around the semispherical configuration of the second roller. The peripheral edge of the second roller also has a circular configuration that is concentric with the axle axis.

The peripheral edge of the first roller is positioned in a first plane and the peripheral edge of the second roller is positioned in a second plane. The first plane and the second plane are parallel to each other and are spaced from each other by an axial spacing. Thus, the axial spacing is between the peripheral edge of the first roller in the first plane and the peripheral edge of the second roller in the second plane.

The attachment projection of the base is positioned in the axial spacing between the peripheral edge of the first roller and the first plane and the peripheral edge of the second roller and the second plane. The attachment projection extends from the base and through the axial spacing to a position outside of the exterior surfaces of the first roller and the second roller.

Thus, it is the principal object of this invention to provide a swivel ball attachment to a white cane that greatly facilitates movement of the cane over a surface, even while maintaining continuous contact with that surface during transit.

Another object of this invention is to provide means to prevent or at least reduce impactive forces from being generated from a surface, through the cane, and to the hand or arm of the user, during application.

Still another object of this invention is to provide means to facilitate the movement of a blind person upon a rough surface, through usage of a ground encountering swivel ball attachment applied to the bottom end of a white cane.

These and other benefits may become more apparent for those skilled in the art upon review of this summary of the invention as provided therein, and upon undertaking a study of a description of its preferred embodiments, in view of the drawings.

### BRIEF DESCRIPTION OF THE DRAWINGS

Further objects and features of the swivel ball attachment or cane tip of this disclosure are set forth in the following detailed description and in the drawing figures.

FIG. 1 is a representation of a perspective view of the cane tip of this disclosure.

FIG. 2 is a representation of a front elevation view of the cane tip of FIG. 1, with it understood that the rear elevation view of the cane tip is a substantial mirror image thereof.

FIG. 3 is a representation of a cross section view of the cane tip of FIG. 2.

FIG. 4 is a representation of a right side elevation view of the cane tip of FIG. 2, with it understood that the left side elevation view of the cane tip is a substantial mirror image thereof.

FIG. 5 is a representation of a bottom plan view of the cane tip of FIG. 2.

FIG. 6 is a representation of a top plan view of the cane tip of FIG. 2.

### DETAILED DESCRIPTION

FIG. 1 is a representation of a perspective view of the cane tip 10 of this disclosure. As represented in FIG. 1, the cane tip 10 has the appearance of a swivel ball construction. The cane tip 10 is basically constructed of a base 12, an axle 14, and a roller 16 or rollers 16, 18. Each of the component parts of the cane tip 10 to be described is constructed of a material that provides the cane tip with sufficient structural strength for functioning in its intended manner.

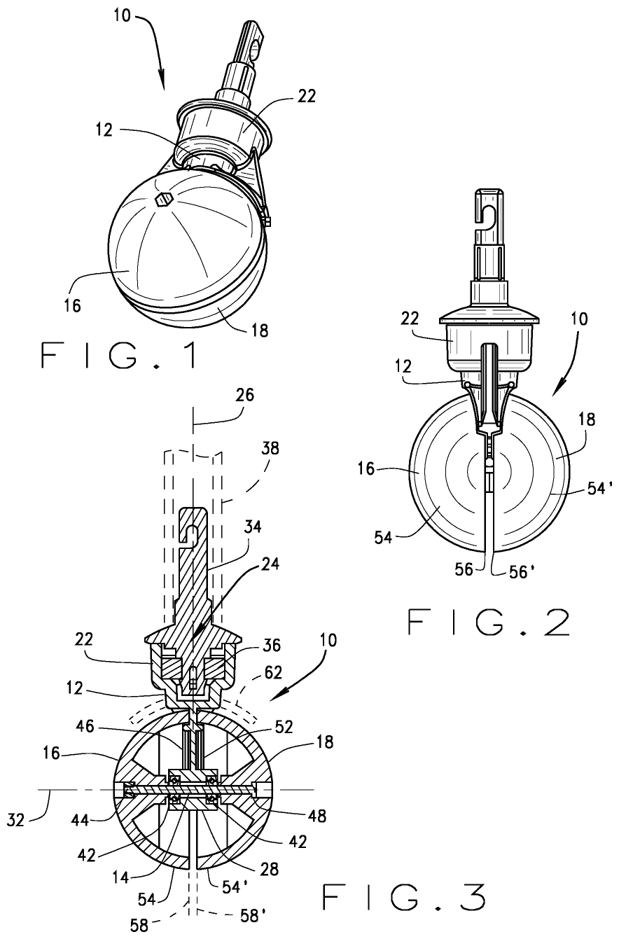

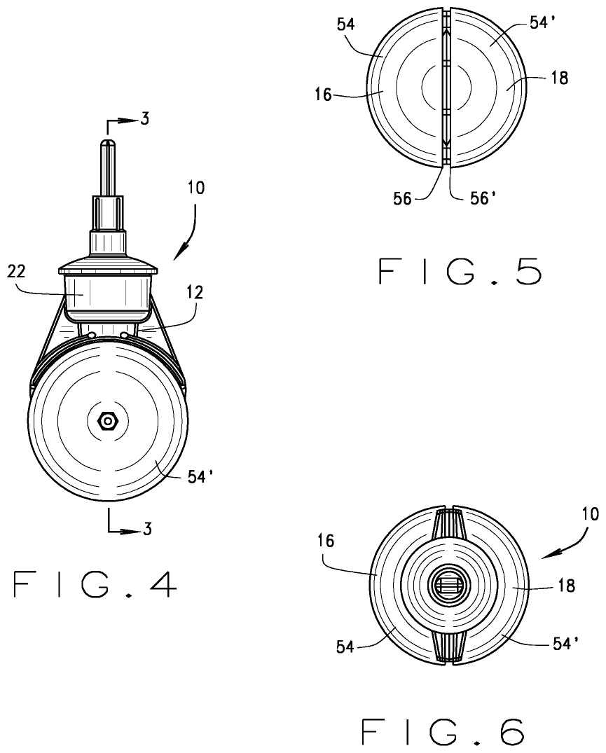

The base 12 has a cylindrical construction at its top end as represented in FIGS. 1-4. The cylindrical construction defines a hollow socket 22 having a top opening 24 into an interior of the socket. The cylindrical construction of the socket 22 has a vertically oriented center axis 26. From the socket 22 the base 12 extends downward to a cylindrical tube 28 at the bottom of the base. The tube 28 has an interior bore extending through the tube with a horizontally oriented center axis 32.

The base has a support shaft or attachment projection 34 that is mounted in the base socket 22 by a bearing assembly 36. The attachment projection 34 extends upward from the socket 22 and the base 12. The base socket 22 and bearing assembly 36 position a center axis 26 of the attachment projection coaxially with and as the same axis 26 of the socket 22. The bearing assembly 36 enables the attachment projection to rotate relative to the base 12 about the axis 26. The upper end of the attachment projection 34 is configured to be attachable to the distal end or lower end of a cane, such as a white cane represented by the dashed lines 38 of FIG. 3. In one example, the attachment projection 34 is configured to be removably attachable to the distal end or lower end of a cane such as the cane disclosed in U.S. Pat. No. 10,898,406, which is incorporated herein by reference. As represented in FIGS. 1-4, the attachment projection is configured with a hook that is removably attachable to a bungee type cord or elastic cord such as that disclosed in the referenced patent. Alternatively, the attachment projection could be configured with another equivalent type of attachment feature, for example a screw threaded connection that is removably attachable to the distal end or lower end of a cane 38. The attachment projection attached to the cane positions the attachment projection 34 and the base socket axis 26 coaxially with and as a same axis as the center axis 26 of the cane.

The axle 14 is on the base 12 below the attachment projection 34. The axle 14 could be an integral part of the base 12, or could be a separate part from the base 12 as represented in FIG. 3. In FIG. 3 the axle 14 is a separate part from the base 12 and is shown mounted in the base tube 28 by a pair of bearing assemblies 42. The axle 14 has a center axis 32 that is coaxial with and the same center axis 32 of the tube 28. The center axis 32 of the tube 28 and the axle 14 is perpendicular with the axis 26 of the socket 22 and the attachment projection 34. The axle 14 mounted by the bearing assemblies 42 in the tube 28 of the base 12 is rotatable in the tube 28 relative to the base 12. The axle 14 mounted in the tube 28 has a first distal end 44 that projects from a first side 46 of the base 12 or the left side of the base in FIG. 3, and a second distal end 48 that projects from a second side 52 of the base 12 or the right side of the base in FIG. 3.

As stated earlier, the cane tip 10 is comprised of a roller that in turn is comprised of a pair of rollers or a first roller 16 and a second roller eighteen. The first roller 16 and the second roller 18 are substantial mirror images of each other, therefore only the first roller 16 is described in detail herein. Reference numbers used in the description of the first roller 16 also label the second roller 18, with the reference numbers of the second roller 18 followed by a prime (′).

The first roller 16 is mounted on the axle first distal end 44 for rotation of the first roller with the axle. The second roller 18 is mounted on the axle second distal end 48 for rotation of the second roller with the axle. Alternatively, the first roller 16 and the second roller 18 could rotate relative to the axle 14.

The first roller 16 and the second roller 18 each have an exterior surface 54, 54′ that has a hemispherical or semispherical configuration. Together, the exterior surfaces 54, 54′ of the first roller 16 and second roller 18 give the roller a spherical configuration. As explained herein, the exterior surfaces 54, 54′ give the roller an exterior surface that is configured to engage against and move across a support surface supporting a user of the cane tip 10, with the roller being rotatable about the center axis 26 of a cane 38 to which the tip 10 is attached, and about the center axis 32 of the axle 14 of the cane tip.

The exterior surface 54 of first roller 16 has a peripheral edge surface 56 that extends around the semispherical configuration of the exterior surface. The peripheral edge surface 56 of the first roller 16 has a circular configuration that is concentric with the axle axis 26. The circular configuration of the first roller peripheral edge surface 56 basically defines a wheel that is rotatable about the axle axis 26. The peripheral edge surface 56 is basically designed to engage with and roll over a support surface when the cane tip 10 is being moved forwardly and rearwardly and to reduce impact forces from being transmitted up the cane to the user's hand and arm.

The spherical exterior surface 54 of the first roller 16 is basically designed to engage with and roll over the support surface when the cane tip 10 is moved from side to side. The spherical configuration of the combined, side by side arrangement of the first roller 16 and second roller 18 enables the cane tip 10 to travel over surfaces while reducing impact forces from traveling up the cane to the hand and arm of a user of the cane tip.

The peripheral edge surface 56 of the first roller 16 is positioned in a first plane 58. The first plane 58 is parallel with the axis 26 of the base socket 22, the attachment projection 34 and the cane 38 when the cane tip 10 is attached to the cane. As represented in FIG. 3, the second roller 18 also has a peripheral edge surface 54′ that is positioned in a second plane 58′ that is parallel with and spaced from the first plane 58.

As represented in FIG. 3, there is an axial spacing between the peripheral edge 56 of the first roller 16 in the first plane 58 and the peripheral edge 56′ of the second roller 18 and the second plane 58′. The base 12 extends through the axial spacing between the first peripheral edge 56 of the first roller in the first plane 58 and the second peripheral edge 56′ of the second roller 18 in the second plane 58′.

In an embodiment of the cane tip, circular gaskets or seals are provided on the opposing surfaces of the first peripheral edge 56 and the second peripheral edge 56′. The gaskets or seals function as a barrier to dirt and keep dirt or other debris from entering the axial space between the first roller 16 and second roller 18 and possibly effecting the performance of the pair of bearing assemblies 42. The rotation of the gaskets or seals on the opposing surfaces of the first peripheral edge 56 and the second peripheral edge 56′ across the opposite sides of the base 12 cleans the dirt or other debris from the gaskets or seals.

In a further embodiment of the cane tip, a hemispherical cover extends from the base 12 over top portions of the first roller 16 and second roller 18 as represented by the dashed lines 62 in FIG. 3. The cover 62 provides further protection of the rollers 16, 18 from dirt or debris entering the axial space between the rollers.

As changes and variations could be made to the above described cane tip without departing from the scope of the disclosure, it is intended that all matter included in the above description and in the accompanying drawings be interpreted as illustrative only and not in a limiting sense, and that the scope of the invention be interpreted and defined by the appended claims.

1. A cane tip comprising:
a base, the base having an attachment projection that is configured to be attachable to a distal end of a cane, the attachment projection having a projection axis that is positioned coaxial with a center axis of a cane when the attachment projection is attached to a distal end of the cane;
an axle on the base, the axle having an axle axis that is perpendicular to the projection axis; and
a roller, the roller having an exterior surface that is configured to engage against and move across a support surface supporting a user of the cane tip, the roller being mounted on the axle for rotation of the roller on the axle and rotation of the exterior surface of the roller around the axle axis.

2. The cane tip of claim 1, further comprising:
the roller having a peripheral edge, the peripheral edge having a circular configuration that is concentric with the axel axis.

3. The cane tip of claim 2, further comprising:
the roller being a first roller;
a second roller, the second roller having an exterior surface that is configured to engage against and move across a support surface supporting a user of the cane tip, the second roller being mounted on the axle for rotation of the second roller on the axle and rotation of the exterior surface of the second roller around the axle.

4. The cane tip of claim 3, further comprising:
the second roller having a peripheral edge, the peripheral edge of the second roller having a circular configuration that is concentric with the axle axis;
the peripheral edge of the first roller being positioned in a first plane;
the peripheral edge of the second roller being positioned in a second plane; and the first plane and the second plane being parallel.

5. The cane tip of claim 4, further comprising:
an axial spacing between the peripheral edge of the first roller in the first plane and the peripheral edge of the second roller in the second plane; and
the base being positioned in the axial spacing between the peripheral edge of the first roller in the first plane and the peripheral edge of the second roller in the second plane.

6. The cane tip of claim 3, further comprising:
the axle being separate from the base and being mounted on the base for rotation of the axle on the base, the axle having a first distal end projecting from a first side of the base and the axle having a second distal end projecting from a second side of the base;
the first roller being mounted on the first distal end of the axle on the first side of the base; and
the second roller being mounted on the second distal end of the axle on the second side of the base.

7. The cane tip of claim 1, further comprising:
the attachment projection being mounted on the base for rotation of the attachment projection around the projection axis relative to the base.

8. The cane tip of claim 1, further comprising:
the attachment projection being attached to a distal end of a white cane.

9. A cane tip comprising:
a base, the base having an attachment projection that is configured to be attachable to a distal end of a cane, the attachment projection having a projection axis that is positioned coaxial with a center axis of a cane when the attachment projection is attached to a distal end of the cane;
an axle on the base, the axle having an axle axis that is perpendicular to the projection axis; and
a roller, the roller having an exterior surface with a spherical configuration, the roller being mounted on the axle for rotation of the roller with the axle.

10. The cane tip of claim 9, further comprising:
the spherical configuration of the roller having a center axis that is concentric with the axel axis.

11. The cane tip of claim 10, further comprising: the roller being comprised of a first roller and a second roller;
the first roller and the second roller having semispherical configurations that together define the spherical configuration of the exterior surface of the roller; and
the first roller and the second roller being mounted on the axle for rotation of the first roller and the second roller with the axle.

12. The cane tip of claim 11, further comprising:
the first roller having a peripheral edge around the semispherical configuration of the first roller, the peripheral edge of the first roller having a circular configuration that is concentric with the axle axis;
the second roller having a peripheral edge around the semispherical configuration of the second roller, the peripheral edge of the second roller having a circular configuration that is concentric with the axle axis;
the peripheral edge of the first roller being positioned in a first plane;
the peripheral edge of the second roller being positioned in a second plane; and
the first plane and the second plane being parallel.

13. The cane tip of claim 12, further comprising:
an axial spacing between the peripheral edge of the first roller in the first plane and the peripheral edge of the second roller in the second plane; and
the base being positioned in the axial spacing between the peripheral edge of the first roller in the first plane and the peripheral edge of the second roller in the second plane.

14. The cane tip of claim 13, further comprising:
the axle being separate from the base and being mounted on the base for rotation of the axle on the base, the axle having a first distal end projecting from a first side of the base and the axle having a second distal end projecting from a second side of the base;
the first roller being mounted on the first distal end of the axle on the first side of the base; and
the second roller being mounted on the second distal end of the axle on the second side of the base.

15. The cane tip of claim 9, further comprising:
the attachment projection being mounted on the base for rotation of the attachment projection around the projection axis relative to the base.

16. The cane tip of claim 9, further comprising:
the attachment projection being attached to a distal end of a white cane.

17. A cane tip attachment to a cane comprising:
a cane;
a cane tip that is attachable to a lower end of the cane;
the cane tip being comprised of a first roller with a semispherical configuration and a second roller with a semispherical configuration;
an axle secured to the first roller and the second roller, the axle holding the first roller and the second roller in a spherical configuration, the first roller and the second roller being rotatable on the axle.

18. The cane tip of claim 17, further comprising:
the cane tip being attachable to an elastic cord provided at the lower end of the cane.

19. The cane tip of claim 17, further comprising:
the cane tip being secured by a screw threaded connection to the lower end of the cane.

20. The cane tip of claim 17, further comprising:
a first peripheral gasket around the semispherical configuration of the first roller; and
a second peripheral gasket around the semispherical configuration of the second roller.
